(19) United States
(12) Patent Application Publication
(10) Pub. No.: US 2010/0139973 A1
(43) Pub. Date: Jun. 10, 2010

(54) MINERAL INSULATED ELECTRIC CABLE TERMINATION

(76) Inventors: James Bredmomd, Edmonton (CA); Robert Holmes, Edmonton (CA)

Correspondence Address: TYCO INTERNATIONAL, 9 ROSZEL ROAD, PRINCETON, NJ, 08540, US

(21) Appl. No.: 11/996,191

(22) PCT Filed: Jul. 14, 2006
(86) PCT No.: PCT/CA2006/001166

§ 371 Date: Feb. 9, 2010

(30) Foreign Application Priority Data
Jul. 20, 2005 (CA) 2,512,687

(51) Int. Cl. H01R 4/18; H02G 15/08; H01R 43/00

(52) U.S. Cl. 174/84 C; 174/84 R; 29/868

(57) ABSTRACT

A mineral-insulated (MI) cable termination assembly and method of manufacturing same is disclosed. The cable termination assembly includes an MI cable having a MI cable conductor, a mineral insulating layer surrounding the MI cable conductor, and an outer metal sheath surrounding the mineral insulating layer. The cable termination assembly also includes an electrical cable having an electrical cable conductor. A connector is provided for electrically connecting the MI cable conductor to the electrical cable conductor. A molded joint surrounds an exposed distal portion of the MI cable conductor and an exposed distal portion of the electrical cable conductor. The molded joint is composed of a polymeric material adhered to the exposed distal portion of the MI cable conductor and the exposed distal portion of the electrical cable conductor.

### FIELD OF THE INVENTION

The invention relates to mineral-insulated electric cables (“MI cables”), and in particular, the invention relates to a termination assembly for MI cables. The invention further relates to a method of connecting an MI cable to an electrical cable.

### BACKGROUND OF THE INVENTION

MI cables are typically used in heating applications, and as electrical conductors where resistance to fire is required or to reduce the magnetic fields associated with most cables. MI cables typically include at least one inner conductor surrounded by a mineral-based insulation layer, such as a highly dielectric magnesium oxide (MgO) powder. The insulation layer is surrounded by an outer sheath composed of a metal material, such as copper or stainless steel.

A MI cable is typically energized by an electrical cable, or by a second MI cable, connected to the end of the MI cable by a termination such as a junction box or connector, which prevents water ingress to the electrical conductors.

Prior MI cable terminations typically require mechanical fittings, such as gland nuts, compression fittings, and swaged connections. These mechanical connections are required to permit the MI cable to be attached to the junction box or connector. Installation of such mechanical connections require shaping of the metal MI cable by the worker at the construction site. A long length of the metal MI cable may be required to transition to the junction box or connector, which can be costly to provide, and difficult and time-consuming to handle. Tight tolerances are required on the mechanical terminations to prevent water ingress, and for approval for use in hazardous areas. Extensive work may be required to perform repairs or maintenance on the mechanical connections or the electrical connections at the end of MI cables.

Accordingly, there is a need for an improved MI cable termination assembly which may be assembled at a manufacturing facility or construction site to reduce costs and which more easily permits connection of the MI cable to the electrical power cable.

### SUMMARY OF THE INVENTION

According to a first aspect of the invention, a cable termination assembly is provided. The cable termination assembly comprises an MI cable having at least one MI cable conductor, a mineral insulating layer surrounding the MI cable conductor, and an outer metal sheath surrounding the mineral insulating layer. The cable termination assembly additionally comprises an electrical cable comprising at least one electrical cable conductor; a connector for electrically connecting the MI cable conductor to the electrical cable conductor; and a molded joint surrounding an exposed distal portion of the MI cable conductor and an exposed distal portion of the electrical cable conductor. The molded joint comprises a polymeric material adhered to at least the exposed distal portion of the MI cable conductor and the exposed distal portion of the electrical cable conductor.

According to a second aspect of the invention, a method of connecting an MI cable to an electrical cable is provided. The MI cable has at least one MI cable conductor surrounded by a mineral insulation layer which is then surrounded by an outer metal sheath. The electrical cable has at least one electrical cable conductor. The method comprises:
a) electrically connecting an exposed distal portion of the at least one MI cable conductor to an exposed distal portion of the at least one electrical cable conductor;
b) placing the exposed distal portions of the at least one MI cable conductor and the at least one electrical cable conductor into a mold;
c) adding a polymeric material into the mold; and
d) curing or hardening of the polymeric material to form a molded joint.

Preferably, the method begins with the step of exposing the distal portions of the MI cable conductors and electrical cable conductors.

### BRIEF DESCRIPTION OF THE DRAWINGS

In the accompanying drawings:

FIG. 1 is a cut-away plan view of the cable termination assembly according a to a preferred embodiment of the present invention;

FIGS. 2A-C are schematic views of various applications for the cable termination assembly of FIG. 1;

FIGS. 3A and 3B show perspective views of two embodiments of molds for forming the molded joint for the cable termination assembly.

### DETAILED DESCRIPTION OF THE PREFERRED EMBODIMENTS

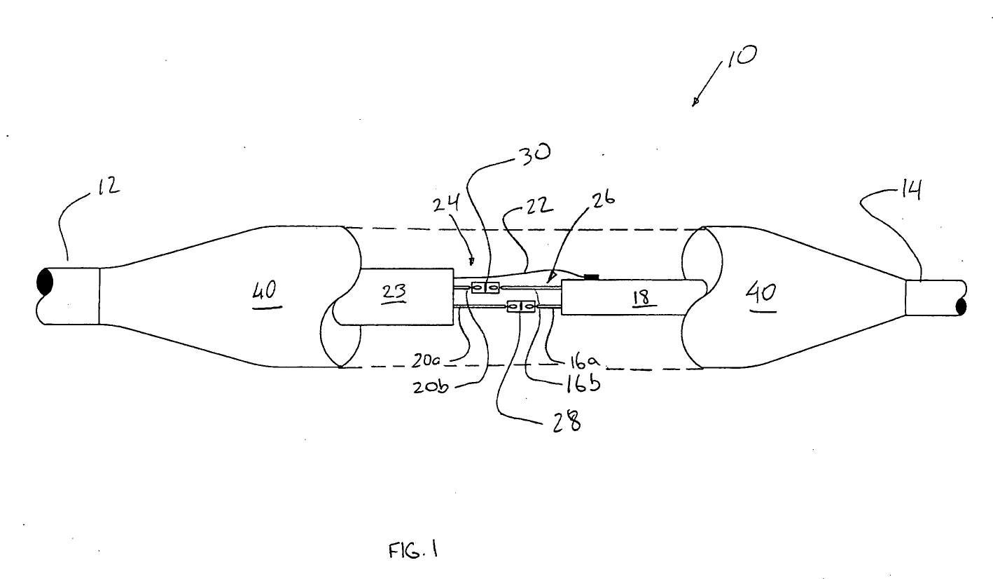

FIG. 1 shows a cable termination assembly 10 according to a preferred embodiment of the present invention. The cable termination assembly 10 includes any suitable electrical cable 12 for energizing a MI cable 14. Preferably, MI cable 14 is a length of MI cable that does not generate heat. For example, the MI cable 14 may be a MI cold lead cable for connection to a hot/cold joint of a MI heating cable or a length of a MI power cable for conducting electricity or the like (as described in more detail below).

The MI cable 14 preferably includes a pair of conductors 16a, 16b surrounded by a magnesium oxide insulation layer (not shown). The MI cable 14 also includes a metal sheath 18 which surrounds the magnesium oxide insulation layer. It will be understood by those skilled in the art that the number of conductors in the MI cable 14 may range from a minimum of one to any suitable number.

The electrical cable 12 may also include a pair of conductors 20a, 20b, and preferably a bonding conductor 22, all surrounded by an outer jacket 23. Preferably, the outer jacket is composed of a polymeric material, but may alternatively be composed of any other suitable material, such as a metal. It will be understood by those skilled in the art that the number of conductors in the electrical cable 12 may range from a minimum of one to any suitable number.

Continuing to refer to FIG. 1, end or distal portions 24, 26 of the electrical cable 12 and MI cable 14, respectively, are exposed to reveal the conductors 16a, 16b of the MI cable and the conductors 20a, 20b and bonding conductor 22 of the electrical cable. The conductors 16a, 20a, and 16b, 20b are electrically connected by crimp-on connectors 28, 30, respectively, or may be terminated by other means, such as soldering. The bonding conductor 22 of the electrical cable 12 is connected to the sheath 18 of MI cable 14.

A joint 40 molded from a polymeric material is adhered to at least the distal end portions of the electrical cable 12 and MI cable 14 to preferably provide a water resistant seal for the termination assembly 10. The water resistant joint is formed upon bonding of the polymeric material to the metal sheath 18 of MI cable 14 and outer jacket 23 of electrical cable 12. In addition, the joint 40 may act to insulate conductors 16a, 20a from conductors 16b, 20b. The polymeric material mechanically connects the MI cable 14 to the electrical cable 14 to provide structural support for the termination assembly 10. The polymeric material may be any polymeric material, such as a pourable epoxy or an injection molded plastic material, such as polyurethane. The pourable epoxy may be a 3M™ Scotchcast™ 2130 Compound.

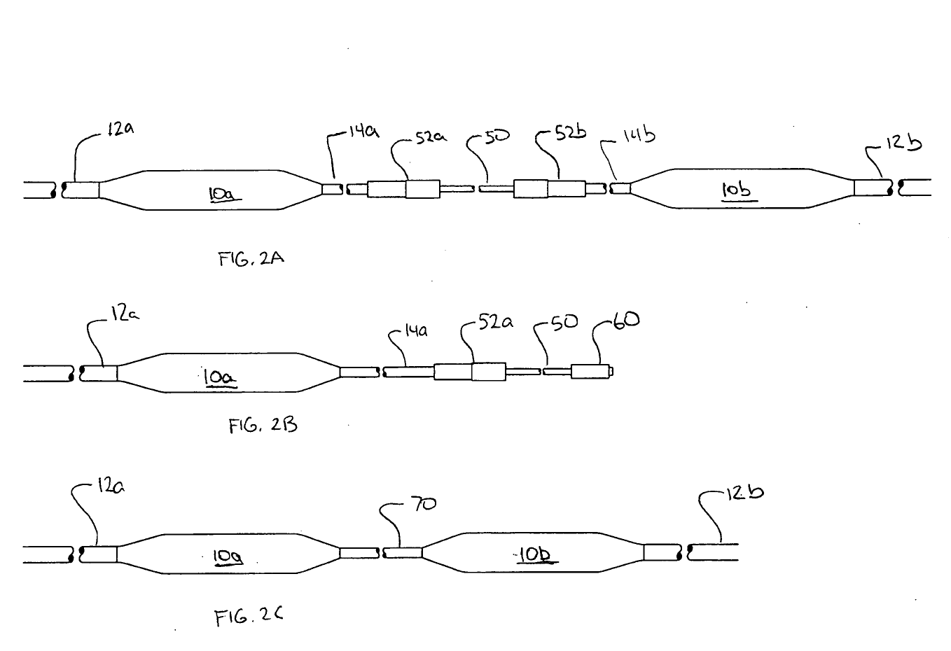

FIGS. 2A-2C show examples of applications of the present invention. Specifically, FIG. 2A shows a power cable 12a which is joined to a MI cable cold lead 14a by a MI cable termination assembly 10a, as described above. The MI cold lead 14a is joined to a MI heating cable 50 by any suitable hot/cold joint 52a. The hot/cold joint 52a is preferably a metal mechanical joint that is typically soldered or welded in order to withstand the heat generated by the MI heating cable. The other end of the MI heating cable 50 may be connected to a second identical hot/cold joint 52b of a second MI cable cold lead 14b. The second MI cable cold lead 14b may be connected to a second power cable 12b by a second termination assembly 10b. In the manner shown in FIG. 2A, several MI heating cables can be electrically connected.

FIG. 2B shows a power cable 12a connected to a MI heating cable 50 in the same manner as shown in FIG. 2A, except that the MI heating cable is terminated by a sealing end cap 60, rather than a second hot/cold joint.

FIG. 2C shows power cables 12a, 12b connected to either end of a MI power cable 70 (i.e. MI cable which does not generate substantial heat) by termination assemblies 10a, 10b, respectively. The embodiment of FIG. 2C is particularly advantageous for using MI cables in electricity conductor applications.

The present invention provides a preferably water resistant MI cable termination assembly which does not require the use of mechanical connectors and may be produced in a factory or at the construction site. Producing the cable termination assembly in a factory provides numerous advantages, such as improving quality control and reducing cost. The present invention also reduces the need to supply longer sections of MI cold lead, which are more difficult to handle and shape in the field.

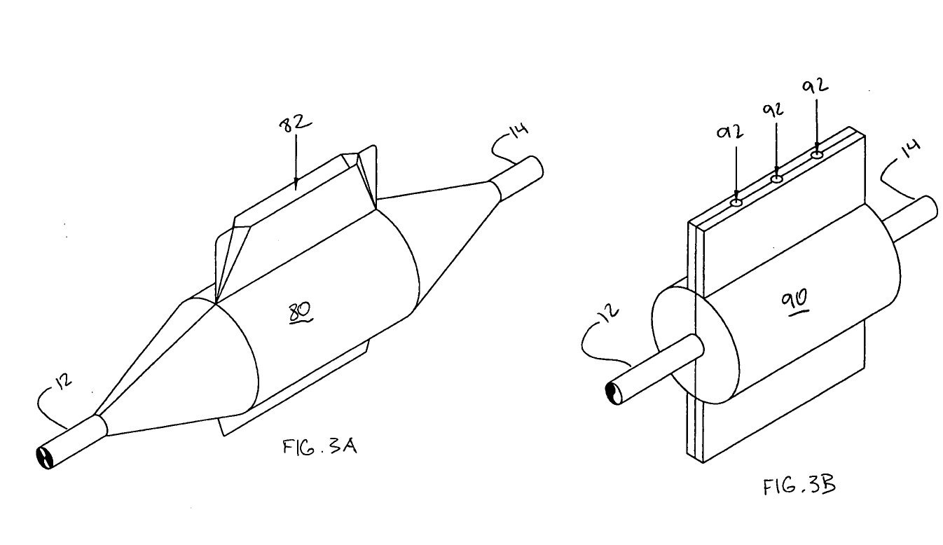

The method of connecting a power cable to a MI cable will now be described with reference to FIGS. 1, 3A, and 3B.

Distal portions 24, 26, respectively, of electrical cable 12 and MI cable 14 are exposed to reveal the MI cable conductors 16a, 16b, electrical cable conductors 20a, 20b, and bonding conductor 22. The conductors 16a, 20a, and 16b, 20b are then electrically connected preferably by crimp-on connectors 28, 30, respectively. It will be understood by those skilled in the art that the conductors may be electrically connected by any other suitable means, such as soldering. The bonding conductor 22 of the electrical cable 12 is connected to the sheath 18 of MI cable 14.

The distal portion 24 of electrical cable 12 and the distal portion 26 of MI cable 14 are placed into a mold. In one embodiment shown in FIG. 3A, the mold may be a clam-shell mold 80. In a second embodiment shown in FIG. 3B, the mold may be an injection mold 90.

A suitable polymeric material may be added to the mold. In the embodiment shown in FIG. 3A, epoxy may be added through opening 82. In the embodiment shown in FIG. 3B, a plastic material such as polyurethane may be injected through openings 92. The polymeric material may be then given time to cure or harden in order to adhere to the cables 12, 14 and to form the molded joint 40. After the polymeric material has cured or hardened sufficiently, the mold is removed.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Every feature described or claimed in this application may be combined with every other feature individually or in combination.

1. A cable termination assembly comprising:
a) an MI cable comprising:
i) at least one MI cable conductor;
ii) a mineral insulating layer surrounding the MI cable conductor;
iii) an outer metal sheath surrounding the mineral insulating layer;
b) an electrical cable comprising at least one electrical cable conductor;
c) a connector for electrically connecting the MI cable conductor to the electrical cable conductor;
d) a molded joint surrounding an exposed distal portion of the MI cable conductor and an exposed distal portion of the electrical cable conductor, wherein the molded joint comprises a polymeric material adhered to at least the exposed distal portion of the MI cable conductor and the exposed distal portion of the electrical cable conductor.

2. The cable termination assembly of claim 1, wherein the molded joint is substantially water resistant.

3. The cable termination assembly of any one of claims 1 or 2, wherein the polymeric material comprises an epoxy.

4. The cable termination assembly of claim 3, wherein the epoxy comprises a pourable epoxy.

5. The cable termination assembly of any one of claims 1 or 2, wherein the polymeric material comprises a plastic material adapted for injection molding.

6. The cable termination assembly of claim 5, wherein the plastic material comprises polyurethane.

7. The cable termination assembly of any one of claims 1-6, wherein the mineral insulation layer comprises a magnesium oxide layer.

8. The cable termination assembly of any one of claims 1-7, wherein the at least one MI cable conductor comprises a pair of MI cable conductors.

9. The cable termination assembly of any one of claims 1-8, wherein the at least one electrical cable conductor comprises a pair of electrical cable conductors.

10. The cable termination assembly of any one of claims 1-9, wherein the electrical cable further comprises a bonding conductor connected to the outer metal sheath, wherein the pair of electrical cable conductors and the bonding conductor are surrounded by an outer jacket.

11. The cable termination assembly of claims 9 or 10, wherein each MI cable conductor is connected to a corresponding electrical cable conductor by a crimp-on connector.

12. The cable termination assembly of claims 9 or 10, wherein each MI cable conductor is connected to a corresponding electrical cable conductor by a soldered connection.

13. The cable termination assembly of any one of claims 1-12, wherein the MI cable comprises a MI cable length adapted not to generate heat.

14. A method of connecting an MI cable to an electrical cable, the MI cable having at least one MI cable conductor, the electrical cable comprising at least one electrical cable conductor, the method comprising:
a) electrically connecting an exposed distal portion of the at least one MI cable conductor to an exposed distal portion of the at least one electrical cable conductor;
b) placing the exposed distal portions of the at least one MI cable conductor and the at least one electrical cable conductor into a mold;
c) adding a polymeric material into the mold; and
d) curing or hardening of the polymeric material to form a molded joint.

15. The method of claim 14 further comprising exposing a distal portion of the at the least one MI cable conductor.

16. The method of claim 14 or 15 further comprising exposing a distal portion of the at least one electrical cable conductor.

17. The method of claim 16 further comprising electrically connecting the exposed distal portion of the at least one MI cable conductor to the exposed distal portion of the at least one electrical cable conductor by a crimp-on connector.

18. The method of claim 16 further comprising soldering the exposed distal portion of the at least one MI cable conductor to the exposed distal portion of the at least one electrical cable conductor.

19. The method of any one of claims 14-18, further comprising connecting a bonding connector of the electrical cable to a sheath of the MI cable.

20. The method of any one of claims 14-19 further comprising removing the mold.

21. The method of any one of claims 14-20, wherein the adding step comprises pouring an epoxy into the mold.

22. The method of claim 21, wherein the mold comprises a clam-shell mold.

23. The method of any one of claims 14-20, wherein the adding step comprises adding a plastic material into an injection mold.

24. The method of claim 23, wherein the plastic material comprises polyurethane.
